(19) United States
(12) Patent Application Publication
(10) Pub. No.: US 2012/0303413 A1
(43) Pub. Date: Nov. 29, 2012

(54) METHODS AND SYSTEMS FOR NETWORK TRAFFIC FORECAST AND ANALYSIS

(75) Inventors: Yufei Wang, Holmdel, NJ (US); Russell J. Green, Fair Haven, NJ (US)

(73) Assignee: VPIsystems Inc., Somerset, NJ (US)

(21) Appl. No.: 13/481,305

(22) Filed: May 25, 2012

Related U.S. Application Data
(60) Provisional application No. 61/490,959, filed on May 27, 2011.

(51) Int. Cl. G06Q 30/02

(52) U.S. Cl. 705/7.31

(57) ABSTRACT

A computer-implemented method and system are provided for forecasting traffic load on a communications network driven by market factors.

### CROSS REFERENCE TO RELATED APPLICATION

This application claims priority from U.S. Provisional Patent Application No. 61/490,959, filed on May 27, 2011, entitled METHODS AND SYSTEMS FOR NETWORK TRAFFIC FORECAST AND ANALYSIS, which is hereby incorporated by reference.

### BACKGROUND

The present application relates generally to mobile communications networks and, more particularly, to methods and systems for network load forecast and traffic analysis.

Mobile communications networks are designed and dimensioned to carry traffic according to the expected amplitude and distribution of demand. If network resources are not available to service this demand, new session requests are denied or queued, and the quality of service (QoS) of existing sessions is compromised, depending on the specifics of the network. From the network subscribers' perspective, this reduction in service (through either denial of new sessions or degradation of existing sessions) reduces their overall quality of experience with the service provider. This phenomenon is known as network congestion. In the case of mobile communication networks, this is the primary determinant of subscriber experience.

Network congestions can be dealt with in two ways. The first solution is a temporary solution that does not add or re-allocate network resources, but rather throttles subscriber usage during peak hours for certain areas of network. The second solution is a fundamental solution that re-dimensions or re-configures the network to meet the changing traffic load.

Network re-dimensioning or re-configuration involves adding new resources to or relocating resources in the network. Such operations typically cannot be done on the fly and overnight. It may take weeks or months because engineering design, hardware ordering and installation, or reconfiguring existing equipment, are time consuming processes. Therefore, network re-dimensioning/re-configuration is not used to address today's traffic load, but traffic load in the future (e.g., in weeks or months). Accurate traffic load forecast is critical for this operation because the future traffic load is the target for network re-dimensioning/re-configuration. If this target is overestimated, the network will be over-dimensioned and the resulting cost can be prohibitively expensive. If this target is underestimated, the resulting network will not have the capacity to accommodate future traffic, resulting degraded subscriber quality of experience or loss of business.

Most forms of network traffic load forecast methodologies as exist today are based on trending of historical network load measurement data to project future network loads. This approach is almost universally used in network dimensioning practices at generally all network operators. Such an approach works only for business as usual networks such as the old landline networks carrying voice and leased circuit traffic over two decades ago. The reason is that in the voice/circuit centric old telecom network, the traffic growth was slight and generally constant year over year. It was highly predictable.

However, in the modern era of telecommunications, IP transport, data centric applications, and mobile broadband are dominant forces. Network traffic is more dynamic and is directly affected by market factors such as new service offerings (like streaming video), new hand-held device launches (such as the iPhone™ smartphone), and marketing campaigns (such as “all-you-can eat” plans and market share changes). The trending based approach will not work in these scenarios because the future network load cannot be derived by extrapolating historical load values. A new approach is needed by network operators to accurately forecast their network load that incorporates impact by market factors. Such market-driven forecast is not only required by network dimensioning operations, but is also critical for conducting what-if impact analysis for business decision making. For example, a network operator may want to consider launching new services, but needs to understand what impact these new services would have on the network performance before the launch.

### BRIEF SUMMARY OF THE DISCLOSURE

A computer-implemented method and system are provided for forecasting traffic load on a communications network driven by market factors. The method, in accordance with one or more embodiments, comprises the steps of: (a) using a computer system to calculate a future network consumption forecast based on current network resource consumption data, predicted future network subscriber population data, current network subscriber population data, predicted future service usage data based at least in part on subscriber device type, and current service usage data based at least in part on subscriber device type; (b) providing a statistical correlation model for network resource consumption and network performance, said statistical correlation model based on historical network performance data and historical network resource consumption data, said historical network resource consumption data being derived, at least in part, from historical subscriber call detail record or IP detail record data; and (c) using the computer system to apply the statistical correlation model from (b) to the future network consumption forecast calculated in (a) to obtain forecasted network performance indicator values for judging network traffic load.

One or more embodiments are directed to a methodology of forecasting future network traffic driven by market forces such as new service launches, new handset introductions, and market share/subscriber growth.

There are two challenges that a market driven network forecast methodology should overcome. The first challenge is how to profile/characterize subscribers, handsets, services, and usages. An appropriate subscriber-service-usage model is used to translate market changes to traffic demand that will be imposed onto the network. The second challenge is how to translate traffic demand into network load (or resource utilization), as technically for some network technologies and some resources, there is no direct relationship between traffic demand and network load.

One or more embodiments are directed to technical approaches that overcome the above two challenges.

An approach to address the first challenge in accordance with one or more embodiments is to establish a subscriber-service-usage model by analyzing subscriber usage records such as CDR (call detail record)/IPDR (IP detail record) data. Traditionally, network operators collect CDR/IPDR data only for billing purpose, and only the usage information for a subscriber is used, such as the minutes of use for voice calls or mega bytes for data sessions. The network information of these usage records is also captured in a limited fashion, such as the switch at the central office serving the caller and the switch at the central office serving the recipient. But such information is generally saved only for the purpose of defending billing or pinpointing customer complaints about QoS.

The subscriber-service-usage model is established by processing CDR/IPDR data to its full extent at a finer granularity. Usage data is first separated by handset by service by time of day, then is mapped to network geography. Average usage profile per subscriber by handset by service is also computed for each geographical region (commonly referred by wireless operators as market).

An approach to address the second challenge in accordance with one or more embodiments is to derive a statistical correlation model between traffic demand and network load from historical data. Such correlation is modeled by traffic type and by individual network elements. Once a statistical relationship is established, traffic demand can be translated to network load.

It should be understood that this methodology is not only limited to providing network load forecast for network dimensioning purposes. The same methodology can also provide network traffic analytics that profiles usage of network resources by different types of subscribers using different types of applications with different types of hand-held devices. Such usage profiling is important to mobile operators and is the basis for differentiated pricing plans for different types of subscribers. Because of the explosive growth of mobile broadband experienced in recent years, mobile operators have drastically increased their capital expenditure spending to lift the capacity of their networks. Such enormous cost must be passed on to the subscribers. Network traffic analytics information essentially allows the mobile operators to charge their subscribers in a fair way according to their usage of network resources.

### BRIEF DESCRIPTION OF THE DRAWINGS

FIG. 1 is a schematic flow diagram illustrating an exemplary method of calculating future network resource consumption in accordance with one or more embodiments.

FIG. 2 is a schematic flow diagram illustrating an exemplary correlation model between network resource consumption and network KPI values in accordance with one or more embodiments.

FIG. 3 is a schematic flow diagram illustrating an exemplary method for calculating final KPI forecasted values in accordance with one or more embodiments.

### DETAILED DESCRIPTION

Various embodiments described herein are directed to techniques for network traffic forecast and analytics. Briefly, current network topology, historical network performance data, and historical usage records such as CDR/IPDR data are used to forecast future network load in accordance with varying market factors. In addition, the breakdown of usage percentages of various network resources by different subscriber/application/handset profiles is also predicted. This information can then be used for various purposes including to proactively re-dimension/re-configure the network and to formulate pricing plans.

Methods and systems are provided that forecast network traffic load through a predictive network model. A network model in accordance with one or more embodiments takes as input data the network topology, historical network performance data, historical subscriber usage data, and market changes in the forms of subscribers, applications and handsets (and other network user devices). The model understands how networking technology works and how traffic flows across networks. It then simulates or predicts the future network behavior reflecting changes in market factors. Network topology comprises a plurality of network elements of various types and their interconnections called links. Network elements and links are the fundamental components of a network. Traffic is processed by a network element and is moved from one location to another over a link. Subscribers generate traffic at the network elements of the edge that propagates towards the core. As an example, in a wireless network, mobile subscribers directly interact with radio transmission network elements called base stations. Traffic originates at the base stations and then flows across the core.

A standard mechanism used by network operators to measure and judge the load of their networks is through Key Performance Indicators (KPIs). Examples of KPIs include bandwidth throughput, interface utilization, max session limit, and CPU utilization. Different types of network elements may have different KPIs. KPI values are collected from network elements in fixed frequency intervals to gauge the network load. Each KPI has a threshold value that reflects its engineering capacity. A threshold-crossing event signal network overload for the particular area of the network element. KPIs may vary by network element type as well as by manufacturer. Collected KPI data accumulated over time is collectively referred as historical network performance data.

The usage of network services by subscribers is captured by CDR for voice and by IPDR for data. CDR/IPDR data is captured primarily for billing purpose. Sometimes such data is also used for quality assurance. But CDR/IPDR has not been used for network dimensioning.

Market factors refer to changes in subscriber population by geographic region, the availability of new services and new handset types, and the introduction of new service plans. These market factors collectively will change the total demand to be imposed on network resources.

The methodologies described herein predict future network KPI values as a result of these market factors.

There is no direct relationship between the market factors and the network KPI values. To bridge the gap, a subscriber usage model is introduced. The usage model characterizes the average behavior of usage of network services by different types of subscribers with respect to various applications and handset types. Historical CDR/IPDR data is used to derive such usage behaviors. Market factors and the subscriber usage model together can predict the future usage of network services.

Next, the usage of network services such as (voice, video streaming) is translated into consumption of network resources (such as channels, bandwidth, sessions, and signaling messages). Each type of network service can be profiled by the type and amount of network resources it consumes at the edge of the network. The usage of network services by geography can then translate into consumption of network resources at the edge. Based on network topology information, the consumption of network resources at the core can also be derived.

Next, the consumption of network resources is translated into network KPI loads. There is also no direct relationship between the two. A statistical correlation model is developed between network KPI values and network resource consumptions using historical performance data. Then the future network KPI values can be computed from the future network resource consumptions.

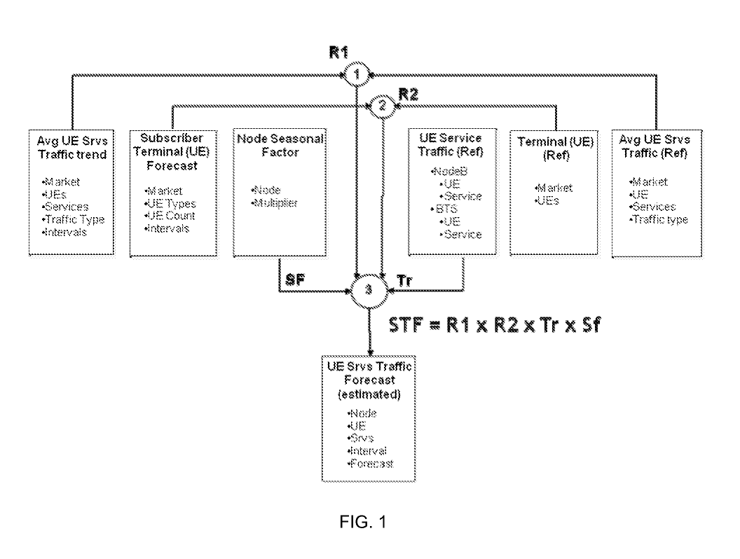

FIG. 1 illustrates an exemplary method of calculating future network resource consumption in accordance with one or more embodiments. It starts with the current resource consumption (Tr) and is scaled by two ratios, R1 and R2. R2 is the ratio of future subscriber population over the current subscriber population (increase or decrease). R1 is the ratio of the average future service usage over the current service usage. Further adjustment of service usage by geography to reflect seasonality is optional (SF). The conversion of service usage to network resource consumption is not explicitly depicted in FIG. 1. All parameters here are tracked separately by handset type and service type for three reasons. First, different handset types may support different types of services, and even for the same service supported by multiple handset types, average usage of the service by subscribers may vary significantly depending on handset type. For example, the usage can increase if a type of handset is more user-friendly in supporting that service. Second, different services may have different usage trends over time. For example, data usage tends to increase, while voice usage tends to decrease. Third, tracking usage separately by service and handset will enable network traffic analytics. Such information can provide insights to network operators for considering service-handset specific pricing.

In the figures, UE means user equipment such as a user mobile device. BTS means a base transceiver station, which is equipment that facilitates wireless communication between user equipment and a network. RAB means radio access bearer, a count of which in use is an example of a KPI used for part of the network. Srvs means services.

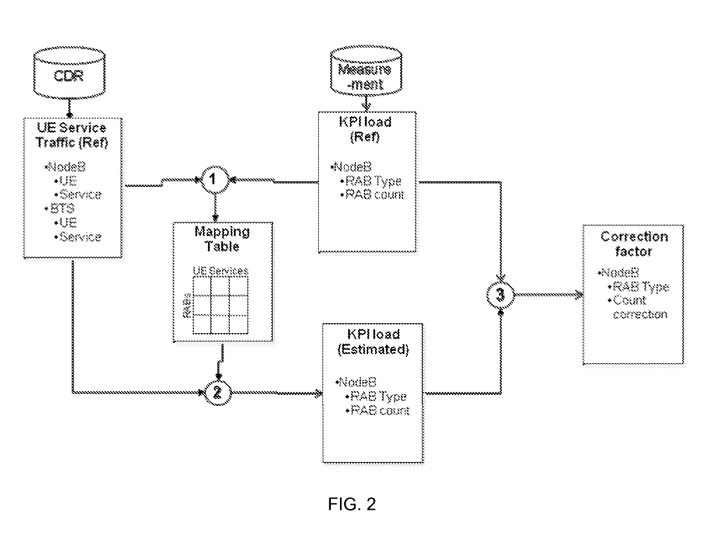

FIG. 2 demonstrates an exemplary correlation model between network resource consumptions and network KPI values in accordance with one or more embodiments. This statistical model takes as inputs the historical network performance data and historical network resource consumption data. The two data sets should be aligned along the same time frame and by the same network geography. The linear model is derived using the least-square fit. The historical network resource consumption data is derived from historical CDR/IPDR data. Least-square fit may introduce certain degree of inaccuracy that essentially implies that the relationship between the two data sets is more complex than a linear one. In order to reduce the inaccuracy, a correction factor is introduced by taking into consideration the difference between the actual current KPI values and the predicted KPI values for the same time period using the model over the network resource consumption data over the same period.

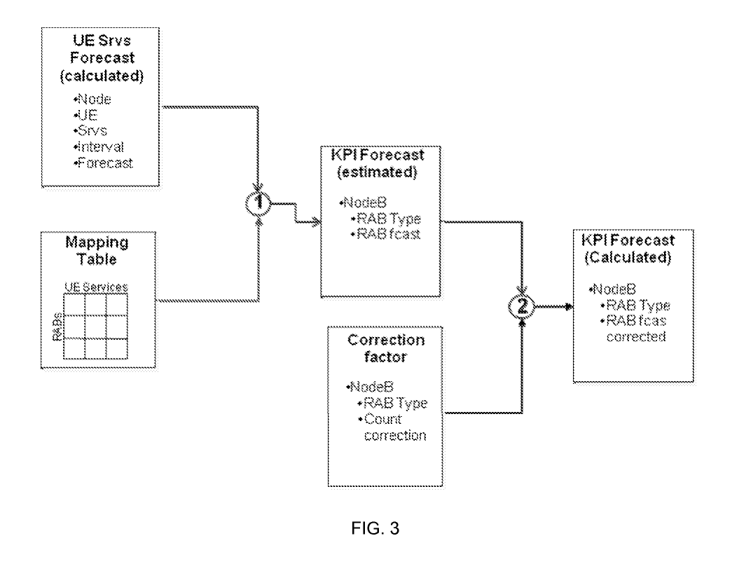

FIG. 3 depicts an exemplary method for calculating the final KPI forecasted values from the outcomes of the previous steps. First the correlation model (from FIG. 2) is applied to the future network consumption forecast (from FIG. 1). The result is the initial estimate of the future network KPI values. Then these initial estimated values are further refined by applying the correction factor (from FIG. 2) to arrive at the final forecasted KPI values.

The processes of the network traffic load forecast and analysis described above may be implemented in software, hardware, firmware, or any combination thereof. The processes are preferably implemented in one or more computer programs executing on a programmable computer system including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer system, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method for forecasting traffic load on a communications network driven by market factors, comprising the steps of:
(a) using a computer system to calculate a future network consumption forecast based on current network resource consumption data, predicted future network subscriber population data, current network subscriber population data, predicted future service usage data based at least in part on subscriber device type, and current service usage data based at least in part on subscriber device type;
(b) providing a statistical correlation model for network resource consumption and network performance, said statistical correlation model based on historical network performance data and historical network resource consumption data, said historical network resource consumption data being derived, at least in part, from historical subscriber call detail record or IP detail record data; and
(c) using the computer system to apply the statistical correlation model from (b) to the future network consumption forecast calculated in (a) to obtain forecasted network performance indicator values for judging network traffic load.

2. The method of claim 1, wherein step (a) comprises using the computer system to calculate the future network consumption forecast by scaling the current network resource consumption data by a ratio of the future network subscriber population data over the current network subscriber population data and by a ratio of the predicted future service usage data over the current service usage data.

3. The method of claim 1, wherein the forecasted network performance indicator values comprise key performance indicator (KPI) values.

4. The method of claim 1, wherein in step (b), the historical network performance data and the historical network resource consumption data comprise data sets that are aligned along a common timeframe and the same network geography.

5. The method of claim 1, wherein in step (b), the statistical correlation model is derived using a least-square fit, and further comprising applying a correction factor to the results of the least-square fit, said correction factor taking into consideration the difference between actual and predicted performance indicator values for the same time period using the model over the network resource consumption data over the same time period.

6. The method of claim 1, wherein the market factors comprise introduction of new user devices, introduction of new service offerings, or marketing campaigns.

7. The method of claim 1, wherein the forecasted network performance indicator values are used for network dimensioning operations or for business decision-making relating to introduction of new user devices or services.

8. The method of claim 7, wherein the network dimensioning operations comprise rehoming or load balancing to make best use of existing assets for forecasted future loads where network capacity is available but not well utilized.

9. A computer system, comprising:
at least one processor;
memory associated with the at least one processor; and
a program supported in the memory for forecasting traffic load on a communications network driven by market factors, the program having a plurality of instructions stored therein which, when executed by the at least one processor, cause the at least one processor to:
(a) calculate a future network consumption forecast based on current network resource consumption data, predicted future network subscriber population data, current network subscriber population data, predicted future service usage data based at least in part on subscriber device type, and current service usage data based at least in part on subscriber device type;
(b) apply a statistical correlation model for network resource consumption and network performance to the future network consumption forecast calculated in (a) to obtain forecasted network performance indicator values for judging network traffic load, said statistical correlation model based on historical network performance data and historical network resource consumption data, said historical network resource consumption data being derived, at least in part, from historical subscriber call detail record or IP detail record data.

10. The system of claim 9, wherein (a) comprises calculate the future network consumption forecast by scaling the current network resource consumption data by a ratio of the future network subscriber population data over the current network subscriber population data and by a ratio of the predicted future service usage data over the current service usage data.

11. The system of claim 9, wherein the forecasted network performance indicator values comprise key performance indicator (KPI) values.

12. The system of claim 9, wherein in (b), the historical network performance data and the historical network resource consumption data comprise data sets that are aligned along a common timeframe and the same network geography.

13. The system of claim 9, wherein in (b), the statistical correlation model is derived using a least-square fit, and a correction factor is applied to the results of the least-square fit, said correction factor taking into consideration the difference between actual and predicted performance indicator values for the same time period using the model over the network resource consumption data over the same time period.

14. The system of claim 9, wherein the market factors comprise introduction of new user devices, introduction of new service offerings, or marketing campaigns.

15. The system of claim 9, wherein the forecasted network performance indicator values are used for network dimensioning operations or for business decision-making relating to introduction of new user devices or services.

16. The system of claim 15, wherein the network dimensioning operations comprise rehoming or load balancing to make best use of existing assets for forecasted future loads where network capacity is available but not well utilized.
